(19) United States
(12) Patent Application Publication
(10) Pub. No.: US 2024/0421551 A1
(43) Pub. Date: Dec. 19, 2024

(54) LASER AMPLIFIER WITH DICHROIC MIRROR FOR INCOUPLING A PUMP LASER BEAM

(71) Applicant: TRUMPF Schweiz AG, Gruesch (CH)

(72) Inventors: Torsten Mans, Aachen (DE); Berthold Schmidt, Stuttgart (DE); Andreas Popp, Markgroeningen (DE)

(21) Appl. No.: 18/740,589

(22) Filed: Jun. 12, 2024

(30) Foreign Application Priority Data
Jun. 16, 2023 (DE) 10 2023 115 784.1

(51) Int. Cl. H01S 3/0941; H01S 3/02; H01S 3/23

(52) U.S. Cl. CPC H01S 3/09415; H01S 3/025; H01S 3/2333

(57) ABSTRACT

A laser amplifier includes a laser-active solid-state rod, through which an input laser beam passes at least twice, and a pump device for generating at least one pump laser beam which is incoupled into the solid-state rod via a first end face of the solid-state rod in order to optically pump the solid-state rod. The input laser beam is incoupled into the solid-state rod via a second end face of the solid-state rod. The input laser beam amplified in the solid-state rod is outcoupled from the solid-state rod in order to form an output laser beam. The laser amplifier further includes a dichroic mirror arranged in a beam path of the pump laser beam between the solid-state rod and the pump device and at an right angle to the pump laser beam. The dichroic mirror is transmissive for the pump laser beam and reflective for the input laser beam.

### CROSS REFERENCE TO RELATED APPLICATIONS

This application claims benefit to German Patent Application No. DE 10 2023 115 784.1, filed on Jun. 16, 2023, which is hereby incorporated by reference herein.

### FIELD

Embodiments of the present invention relate to a laser amplifier for amplifying an input laser beam to form an amplified output laser beam.

### BACKGROUND

A laser amplifier has been disclosed by EP 1 507 321 A1, for example. In the case of this known laser amplifier, a pump laser beam is incoupled into a gain medium via one, the first, end face thereof and an input laser beam is incoupled into the gain medium via the other, the second, end face thereof. After passing through the gain medium, the input laser beam is deflected from the beam path of the oppositely directed input laser beam by means of a dichroic plate arranged obliquely with respect to the pump laser beam, said dichroic plate being transmissive for the pump laser beam and reflective for the input laser beam, and is reflected back by means of a mirror and is incoupled into the gain medium again via the first end face by means of the dichroic plate, in the same direction as the pump laser beam. The input laser beam amplified twice in the gain medium is outcoupled via the second end face and is deflected from the oppositely directed beam path of the incident input laser beam as an output laser beam by means of an optical isolator.

Furthermore, U.S. Pat. No. 6,141,143 discloses a laser amplifier in which a first and a second pump laser beam are incoupled into a laser crystal in each case via opposite crystal end faces. By means of a mirror arranged obliquely with respect to the first pump laser beam, said mirror being transmissive for the first pump laser beam and reflective for an input laser beam, the input laser beam is incoupled into the laser crystal via one crystal end face, in the same direction as the first pump laser beam. The input laser beam amplified in the laser crystal is outcoupled via the other crystal end face and is split from the oppositely directed second pump laser beam by means of a mirror arranged obliquely with respect to the second pump laser beam, said mirror being transmissive for the second pump laser beam and reflective for the amplified output laser beam, in order to form the output laser beam.

Single-emitter pump diodes with fiber coupling are usually used as a pump device. The fiber is complexly wound and the fiber end on the outcoupling side is mounted accordingly. The pump laser beam emerging from the fiber end on the outcoupling side is projected onto the end face of the solid-state rod by corresponding optics. The pump radiation is homogenized here by the propagation along the fiber.

### SUMMARY

Embodiments of the present invention provide a laser amplifier for amplifying an input laser beam to form an amplified output laser beam. The laser amplifier includes a laser-active solid-state rod having two mutually opposite end faces. The input laser beam passes through the solid-state rod at least twice. The laser amplifier further includes a pump device for generating at least one pump laser beam, which is incoupled into the solid-state rod via a first end face of the two end faces of the solid-state rod in order to optically pump the solid-state rod. The input laser beam is incoupled into the solid-state rod via a second end face of the two end faces of the solid-state rod. The input laser beam amplified in the solid-state rod is outcoupled from the solid-state rod in order to form the output laser beam. The laser amplifier further includes a dichroic mirror arranged in a beam path of the pump laser beam between the solid-state rod and the pump device. The dichroic mirror is arranged at an right angle to the pump laser beam. The dichroic mirror is transmissive for the pump laser beam and reflective for the input laser beam.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a laser amplifier according to a first embodiment of the invention comprising a single single-emitter laser diode and comprising a double amplifier pass;

FIG. 2 shows a laser amplifier according to a second embodiment of the invention comprising a single single-emitter laser diode and comprising a quadruple amplifier pass;

FIG. 3a shows a laser amplifier according to a third embodiment of the invention comprising a plurality of single-emitter laser diodes and comprising a double amplifier pass; and

FIG. 3b shows an intensity distribution of the plurality of single-emitter laser diodes of the laser amplifier shown in FIG. 3a according to embodiments of the invention.

### DETAILED DESCRIPTION

Embodiments of the present invention provide alternative beam guiding in a laser amplifier.

According to embodiments of the invention, in a beam path of a pump laser beam between a solid-state rod and a pump device, a dichroic mirror is arranged at right angles to the pump laser beam, which is transmissive for the pump laser beam and reflective for an input laser beam to be incoupled.

In contrast to EP 1 507 321 A1, where the input laser beam is deflected from the beam path of the pump laser beam by means of a dichroic plate and is reflected back by means of a separate mirror outside the beam path of the pump laser beam, according to embodiments of the invention the input laser beam is reflected back for a second pass through the solid-state rod by means of a dichroic mirror arranged at right angles to the pump laser beam in the beam path of the pump laser beam.

In a preferred embodiment, a beam splitter device is arranged in the oppositely directed beam path of the input laser beam to be incoupled and of the amplified input laser beam outcoupled from the solid-state rod, and splits the amplified input laser beam outcoupled from the solid-state rod from the input laser beam to be incoupled in order to form the output laser beam. In one preferred development with a polarized input laser beam to be incoupled, the beam splitter device has a polarization beam splitter and also a λ/4 plate arranged between the solid-state rod and the polarization beam splitter in order that the outcoupled amplified input laser beam, on the basis of its polarization rotated by the λ/4 plate, is split from the input laser beam to be incoupled at the polarization beam splitter. For a third and fourth pass of the input laser beam through the solid-state rod, a further polarization beam splitter is arranged between the polarization beam splitter and the λ/4 plate, said further polarization beam splitter being transmissive for the input laser beam to be incoupled and for the input laser beam that has passed through the λ/4 plate four times, and being reflective for the input laser beam that has passed through the λ/4 plate twice, and directing the input laser beam that has passed through the λ/4 plate twice onto a back-reflecting mirror. Furthermore, a Faraday rotator can be arranged between the two polarization beam splitters, said Faraday rotator changing the polarization of the input laser beam passing through and that of the quadruply amplified input laser beam in particular in the same direction of rotation. Preferably, the Faraday rotator changes the input laser beam respectively passing through rotatively by 45°. The Faraday rotator together with the polarization beam splitters adjacent on both sides can also be configured as a Faraday isolator.

Preferably, the pump device has one single-emitter pump diode for generating the pump laser beam or a plurality of single-emitter pump diodes for generating a plurality of parallel-spaced pump laser beams. In the latter case, the plurality of single-emitter pump diodes are preferably arranged offset with respect to one another in a direction transversely with respect to the pump laser beams.

Proceeding from the at least one single-emitter pump diode, the pump laser beam can be guided to the solid-state rod by means of an optical fiber (e.g. glass fiber) and the pump laser beam emerging from the fiber end on the outcoupling side can be projected onto the end face of the solid-state rod by corresponding optics. In this case, the optical fiber also serves for homogenizing the pump laser beam, i.e. for attaining a homogeneous intensity distribution over the fiber cross-section at the fiber end on the outcoupling side. However, the 1 to 1.5 m long optical fiber has to be guided and wound, which usually necessitates laborious manual work and requires a large amount of installation space in the laser amplifier. In addition, the waveguiding in multimode fibers leads to mechanical vibrations being coupled to the pump laser radiation, which as a consequence in turn imposes additional (intensity) noise on the laser beam to be amplified.

Alternatively, proceeding from the at least one single-emitter pump diode, the at least one pump laser beam can also be incoupled with free-space propagation, i.e. without pump laser beam homogenization, into the first end face. The pump laser radiation of the individual single-emitter pump diodes is projected directly onto the end face of the solid-state rod, and so there are excited and non-excited areas on the end face. The pump laser radiation is distributed as it propagates along the solid-state rod. Moreover, the input laser beam passes through the pumped solid-state rod at least twice, as a result of which, even without a specific homogenizer, a further homogenization of the input laser beam occurs. As a result of the free-space propagation, the optical efficiency is increased since the losses in the course of incoupling into the fiber are avoided. In some instances, optical systems necessary for the incoupling into the optical fiber can also be obviated. Overall, typical incoupling losses into the fiber of 5 to 10 percentage points can thus be avoided since no optical fiber is required. Without an optical fiber, the laser amplifier can be constructed more compactly and also in an automated manner since required optical systems are readily positionable and adjustable with the aid of robots. The amplified laser beam additionally has much less noise. By contrast, an optical fiber cannot be laid in an automated manner, but rather requires manual effort.

Furthermore, the laser amplifier can have a laser beam source, such as e.g. a seed laser, for generating the input laser beam.

Further advantages of the invention are evident from the description and the drawing. Similarly, the features mentioned above and those yet to be explained further can be used in each case individually or together in any desired combinations. The embodiments shown and described should not be understood as an exhaustive enumeration, but rather are of an exemplary character for describing the invention.

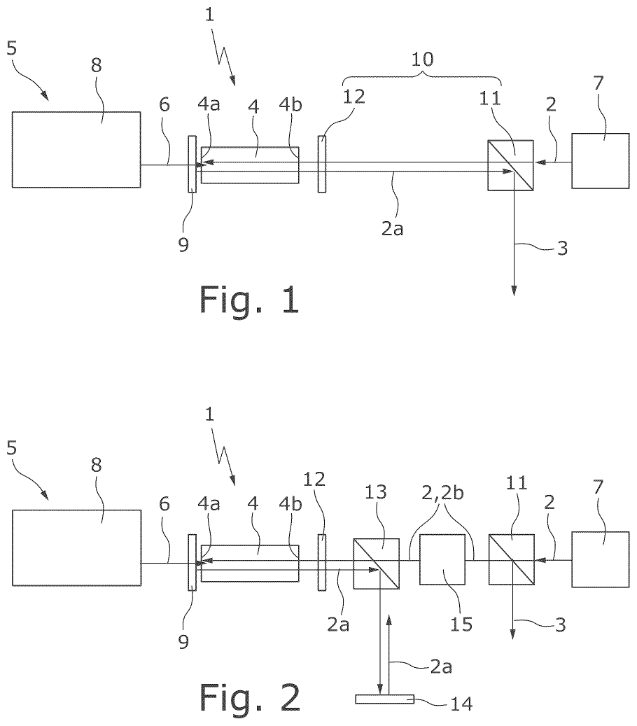

The laser amplifier 1 shown in FIG. 1 serves for amplifying an input laser beam 2 to form an amplified output laser beam 3.

The laser amplifier 1 has a laser-active solid-state rod 4 having two mutually opposite end faces 4a, 4b, through which rod the input laser beam 2 passes twice, a pump device 5 for generating a pump laser beam 6, and a laser beam source (e.g. seed laser) 7 for generating the input laser beam (e.g. seed laser beam) 2. The solid-state rod 4 is for example a cylindrical Yb: YAG crystal having a diameter of e.g. 3 mm, a length of e.g. 10 mm and a Yb doping of e.g. 3%. The pump device 5 can be formed for example by a single-emitter pump diode 8. In the case of a Yb: YAG crystal, the pump device 5 emits a pump wavelength of 941 nm and the laser beam source 7 emits laser radiation having a wavelength of 1030 nm.

Via one, the first, end face 4a of the solid-state rod 4, the pump laser beam 6 is incoupled into the solid-state rod 4 in order to optically pump the solid-state rod 4. Proceeding from the single-emitter pump diode 8, the pump laser beam 6 can be incoupled with free-space propagation into the first end face 4a. Alternatively, the pump laser beam 6 can also be guided to the solid-state rod 4 by means of an optical fiber and the pump laser beam 6 emerging from the fiber end on the outcoupling side can be projected onto the first end face 4a by corresponding optics.

In the beam path of the pump laser beam 6, between solid-state rod 4 and pump device 5, a dichroic mirror 9 is arranged at right angles to the pump laser beam 6, which is transmissive for the pump laser beam 6 and reflective for the input laser beam 2. The input laser beam 2 is incoupled into the solid-state rod 4 via the other, the second, end face 4b of the solid-state rod 4 and passes through the solid-state rod 4, as a result of which it is amplified. The input laser beam 2 emerges from the solid-state rod 4 via the first end face 4a and is reflected back at the dichroic mirror 9. The reflected input laser beam 2 enters the solid-state rod 4 again via the first end face 4a of the solid-state rod 4, passes through the solid-state rod 4 again, as a result of which it is amplified a second time, and emerges as a doubly amplified input laser beam 2a from the solid-state rod 4 via the second end face 4b.

A beam splitter device 10 is arranged in the oppositely directed beam path of the input laser beam 2 to be incoupled and of the doubly amplified input laser beam 2a outcoupled from the solid-state rod, and splits the outcoupled doubly amplified input laser beam 2a from the input laser beam 2 to be incoupled. In the case of a polarized input laser beam 2, as shown in FIG. 1, the beam splitter device 10 can have a polarization beam splitter 11 and a λ/4 plate 12 arranged between solid-state rod 4 and polarization beam splitter 11. On the basis of its polarization rotated by the λ/4 plate 12, the outcoupled doubly amplified input laser beam 2a is split from the input laser beam 2 to be incoupled at the polarization beam splitter 11 in order to form the output laser beam 3.

The laser amplifier 1 shown in FIG. 2 differs from FIG. 1 by virtue of an additional third and fourth pass of the input laser beam 2 through the solid-state rod 4, as a result of which a quadruply amplified input laser beam 2b is generated, which forms the output laser beam 3. For this purpose, a further polarization beam splitter 13 is arranged between polarization beam splitter 11 and λ/4 plate 12, said further polarization beam splitter being arranged obliquely in the beam path of the pump laser beam 6 and obliquely in the beam path of the input laser beam 2 to be incoupled and of the quadruply amplified input laser beam 2b. Furthermore, a Faraday rotator 15 is arranged between the two polarization beam splitters 11, 13, said Faraday rotator changing the polarization of the input laser beam 2 passing through or that of the quadruply amplified input laser beam 2b in particular in the same direction of rotation.

The polarization beam splitter 13 is transmissive for the input laser beam 2 to be incoupled and for the quadruply amplified input laser beam 2b that has passed through the λ/4 plate 12 four times, and reflective for the doubly amplified input laser beam 2a that has passed through the λ/4 plate 12 twice. At the polarization beam splitter 13, the outcoupled doubly amplified input laser beam 2a is split from the oppositely directed input laser beam 2 and is directed onto a mirror 14, which reflects back the doubly amplified input laser beam 2a. The doubly amplified input laser beam 2a enters the solid-state rod 4 via the second end face 4b, passes through the solid-state rod 4, is reflected back at the dichroic mirror 9, passes through the solid-state rod 4 again, as a result of which it is amplified twice again, and emerges as a quadruply amplified input laser beam 2b from the solid-state rod 4 via the second end face 4b. At the polarization beam splitter 11, the quadruply amplified input laser beam 2b is split from the oppositely directed input laser beam 2 in order to form the output laser beam 3.

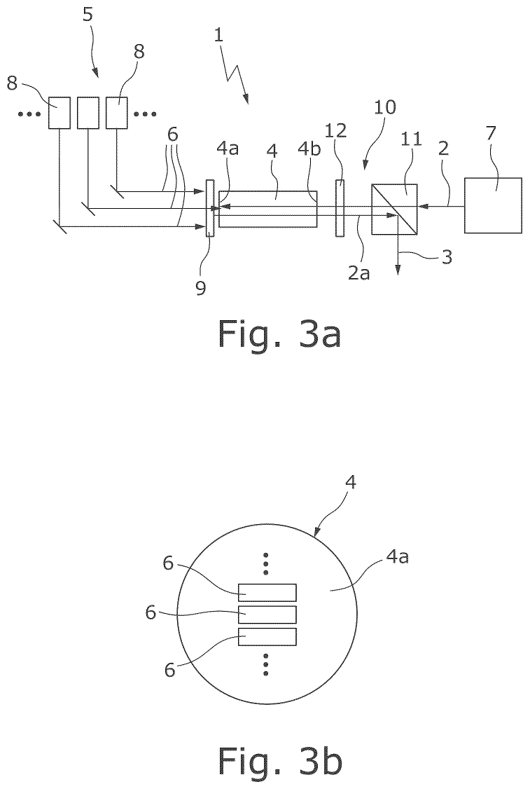

The laser amplifier 1 shown in FIG. 3a differs from FIG. 1 in that the pump device 5 has a plurality of, here merely by way of example three, single-emitter pump diodes 8 for generating a plurality of, here three, parallel-spaced pump laser beams 6. The parallel-spaced pump laser beams 6 of the single-emitter pump diodes 8 lie in a common plane and are arranged offset with respect to one another in a direction transversely with respect to the pump laser beams 6. FIG. 3b shows the associated intensity distribution of the pump laser beams 6 incident on the first end face 4a of the solid-state rod 4.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 laser amplifier
2 input laser beam
2a amplified input laser beam
2b amplified input laser beam
3 output laser beam
4 solid-state rod
4a first end face
4b second end face
5 pump device
6 pump laser beam
7 laser beam source
8 single-emitter pump diode
9 dichroic mirror
10 beam splitter device
11 polarization beam splitter
12 λ/4 plate
13 further polarization beam splitter
14 back-reflecting mirror
15 Faraday rotator

1. A laser amplifier for amplifying an input laser beam to form an amplified output laser beam, the laser amplifier comprising:
a laser-active solid-state rod having two mutually opposite end faces, wherein the input laser beam passes through the solid-state rod at least twice,
a pump device for generating at least one pump laser beam which is incoupled into the solid-state rod via a first end face of the two end faces of the solid-state rod in order to optically pump the solid-state rod, wherein the input laser beam is incoupled into the solid-state rod via a second end face of the two end faces of the solid-state rod, and wherein the input laser beam amplified in the solid-state rod is outcoupled from the solid-state rod in order to form the output laser beam, and
a dichroic mirror arranged in a beam path of the pump laser beam between the solid-state rod and the pump device, wherein the dichroic mirror is arranged at an right angle to the pump laser beam, and the dichroic mirror is transmissive for the pump laser beam and reflective for the input laser beam.

2. The laser amplifier as claimed in claim 1, further comprising a beam splitter device arranged in an oppositely directed beam path of the input laser beam to be incoupled and of the amplified input laser beam to be outcoupled from the solid-state rod, wherein the beam splitter device is configured to separate the amplified input laser beam outcoupled from the solid-state rod from the input laser beam to be incoupled in order to form the output laser beam.

3. The laser amplifier as claimed in claim 2, wherein the input laser beam to be incoupled is polarized, and wherein the beam splitter device comprises a polarization beam splitter and a λ/4 plate arranged between the solid-state rod and the polarization beam splitter.

4. The laser amplifier as claimed in claim 3, further comprising a second polarization beam splitter arranged between the polarization beam splitter and the λ/4 plate for a third pass and a fourth pass of the input laser beam through the solid state rod, wherein the second polarization beam splitter is transmissive for the input laser beam to be incoupled and for the amplified input laser beam that has passed through the λ/4 plate four times, and the second polarization beam splitter is reflective for the input laser beam that has passed through the λ/4 plate twice and directs the input laser beam that has passed through the λ/4 plate twice onto a back-reflecting mirror.

5. The laser amplifier as claimed in claim 4, further comprising a Faraday rotator arranged between the polarization beam splitter and the second polarization beam splitter.

6. The laser amplifier as claimed in claim 1, wherein the pump device comprises at least one single-emitter pump diode for generating the pump laser beam.

7. The laser amplifier as claimed in claim 6, wherein the pump device comprises a plurality of single-emitter pump diodes for generating a plurality of parallel-spaced pump laser beams.

8. The laser amplifier as claimed in claim 7, wherein the plurality of parallel-spaced pump laser beams of the single-emitter pump diodes are arranged offset with respect to one another in a direction transversely with respect to the pump laser beams.

9. The laser amplifier as claimed in claim 6, wherein the pump laser beam, proceeding from the at least one single-emitter pump diode, is incoupled with free-space propagation into the first end face of the solid-state rod.

10. The laser amplifier as claimed in claim 1, further comprising a laser beam source for generating the input laser beam.
